(19) United States
(12) Patent Application Publication
(10) Pub. No.: US 2018/0246556 A1
(43) Pub. Date: Aug. 30, 2018

(54) CIRCUIT FOR CONTROLLING A POWER SUPPLY AND METHOD OF OPERATION THEREOF

(71) Applicant: STMicroelectronics S.r.l., Agrate Brianza (IT)

(72) Inventors: Alfio Pasqua, Piedimonte Etneo (IT); Salvatore Tumminaro, Marianopoli (IT)

(21) Appl. No.: 15/706,135

(22) Filed: Sep. 15, 2017

(30) Foreign Application Priority Data
Feb. 28, 2017 (IT) 102017000022263

(51) Int. Cl. G06F 1/30; H02J 9/06; H02J 7/00; G06F 1/24; H02M 3/156; G05F 1/614

(52) U.S. Cl. CPC G06F 1/30; H02J 9/061; H02J 7/0068; G05F 1/614; G06F 1/24; H02M 3/156; H02J 9/062

(57) ABSTRACT

A control circuit for switched power supplies, for example for battery chargers, including a driving comparator of the generator of the primary current peaks generated by a power transistor that drives a load via a transformer. The aforementioned driving comparator has comparison inputs coupled to an amperometric sensor and to a circuit for determining the value of the aforementioned primary current peaks, for which the voltage applied to the load is a function of the value of the primary current peaks. The determination circuit is coupled to at least one feedback comparator and configured to regulate the value of the primary current peaks, thereby regulating the voltage applied to the load keeping the mean frequency, of the peaks close to the oscillation frequency of the clock that drives the generator.

### CROSS-REFERENCE TO RELATED APPLICATIONS

This application claims priority to Italian Application No. 102017000022263, filed on Feb. 28, 2017, which application is hereby incorporated herein by reference.

### TECHNICAL FIELD

This disclosure relates generally to control circuits, and in particular embodiments to a circuit for controlling a power supply and a method of operation thereof.

### BACKGROUND

An option used in the field of switching power supplies with galvanic isolation between output voltage and input voltage may involve implementing control feedback using an optocoupler that, in addition to closing the control loop, also enables galvanic isolation to be implemented.

Another option used may involve the use of zero-voltage switching (ZVS) systems in which the power transistor (for example a power MOS) can be powered up when the drain voltage reaches its lowest value, for example using a zero crossing detector (ZCD) circuit connected to a similarly named pin, with the switching frequency not being fixed but dependent on the input voltage and load conditions.

In other solutions, the switching frequency may be fixed and determined by an internal oscillator.

In the aforementioned cases, the control method is “current mode”, in which the current peak on the primary side of the transformer is determined by the voltage value on an input pin and by the feedback circuit, such as to be proportional to an error signal obtained by comparing the output voltage and an internal reference of the error amplifier.

The term “control method” is intended to demonstrate that there are two main control methods for the application discussed herein: one known as “current mode” and another known as “voltage mode”, with one or more embodiments of this disclosure involving the “current mode” control method.

These two control methods refer to the method used to generate the primary peak current and/or to the generation of the switched signal (for example PWM) for driving a power transistor (for example power MOS), as opposed to the possible objective of regulation, which may relate to the output voltage Vout (CV mode or constant voltage mode) or the current Tout (CC mode or constant current mode).

In both of the cases considered above, it is possible to use a compensating network obtained using a filter (including, for example, a network RC with two capacitors and one resistor) connected to the input pin on the primary side and by the network RC connected to the error amplifier arranged on the secondary side.

Switching power supplies with galvanic isolation between the output voltage and input voltage in which the feedback from the output voltage is provided without using an optocoupler have also been proposed, operating directly from the primary side via an auxiliary winding. In this case, the information relating to the output voltage is acquired via said auxiliary winding, with an internal sampler (for example a sample & hold circuit, also abbreviated as S&H) which acquires a partition of the auxiliary voltage at the instant that the transformer is demagnetized. At this instant, this voltage may be seen, apart from the turns ratio, as identical to the output voltage with the addition of the threshold voltage of the recirculation diode, which is negligible and in any case can be compensated with an appropriately chosen scaling divider, the threshold voltage being independent of the load. The voltage thus sampled can be compared with an internal reference using an error amplifier, as in the preceding cases. Again in this case, there is an external network connected to the aforementioned input pin to create the compensating network.

For the sake of completeness, a new class of device enabling galvanic isolation between primary and secondary without using an optocoupler can also be mentioned. These devices may for example incorporate a data link between two chips, encapsulated in a single package and isolated galvanically according to prevailing standards (e.g. UL1577 standard). In such a diagram, the feedback voltage can generate, for example using an error amplifier, a signal on the secondary side that, once digitized, can be transferred to the primary side via a galvanically isolated link, before being converted back to analog.

In fixed-frequency non-isolated flyback applications, control feedback can be provided by connecting a partition of the output voltage directly to a feedback pin of the primary device containing the error amplifier circuit that, using an external network, can set the compensation for controlling the output voltage.

There may be a need for improved solutions, for example in terms of reducing application cost by using fewer external components.

### SUMMARY

One or more embodiments may be applied to the control of switching power supplies that can, for example, be used in battery chargers for mobile communication devices.

One or more embodiments address the need for improved solutions, for example in terms of reducing application cost by using fewer external components.

One or more embodiments may concern a corresponding power supply, a corresponding apparatus (for example a battery charger for mobile communication devices including such a power supply) and a corresponding method.

One or more embodiments may provide an innovative voltage control (CV) solution that obviates the need for external compensating networks for flyback converters with isolated or non-isolated feedback.

One or more embodiments may be applied to converters for PWM switching power supplies with or without galvanic isolation between the primary side, that can be connected directly to the domestic network (for example 220 V AC), and regulated output voltage. One or more embodiments may be applied to battery chargers, for example quick charges (QC), converters and various solutions for controlling electromagnetic interference (EMI).

One or more embodiments may support a near-constant switching frequency against the variation in the current of the load in switched-mode power supply (SMPS) flyback converters with ON-OFF control, furthermore facilitating achievement of a harmonic content of the main switching signals that is similar to the content of fixed-frequency SMPS flyback converters.

One or more embodiments may involve inserting means for optimizing the primary peak current against variation of the load into ON-OFF control, thereby facilitating achievement of a constant (mean) switching frequency over a wide range of possible variations in the current of the load, thereby ensuring that the harmonic content of the main switching signals is similar to the content of fixed-frequency converters.

### BRIEF DESCRIPTION OF THE DRAWINGS

One or more embodiments are described below by way of non-limiting example with reference to the attached figures, in which:

FIG. 1 is an example block diagram of a switching converter with on-off control;

FIG. 2 is an example block diagram of some embodiments;

FIG. 3 shows a possible example implementation of one of the elements in FIG. 2;

FIGS. 4 and 5 are example block diagrams of some embodiments;

FIG. 6 shows a possible example implementation of some embodiments; and

FIG. 7 including three portions indicated respectively using (a), (b) and (c), includes example diagrams of the possible progression of some signals in some embodiments.

### DETAILED DESCRIPTION OF ILLUSTRATIVE EMBODIMENTS

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

The references used here are provided merely for convenience and as such do not define the scope of protection or the scope of the embodiments.

By way of introduction to the detailed description of examples of one or more embodiments, it would be useful to summarize some of the observations made in relation to the prior art.

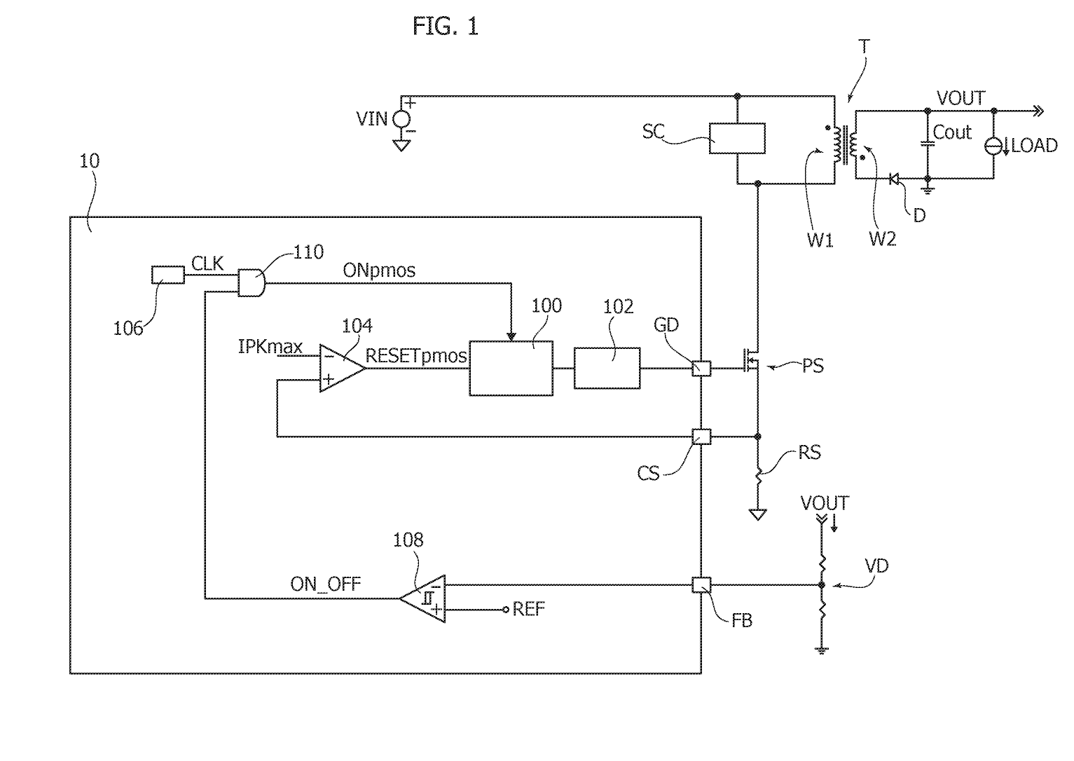

In this regard, it can be noted that, independently of the different considerations set out below, the diagrams in FIGS. 1, 2, 4 and 5 show possible example embodiments of a switching power supply, such as a power supply that can be used in any of the apparatuses mentioned above as possible applications of one or more embodiments.

For the purposes of the present disclosure, reference can therefore be made to a power supply that can include a transformer T having a primary winding Wi and a secondary winding W2.

An input voltage VIN can be applied to the primary winding W1, while an output voltage VOUT designed to be applied to a LOAD can be obtained from the ends of the secondary winding W2. At the ends of the secondary winding W2, where a recirculation diode D may be inserted, there is an output capacitor Cout that, like the anode of the diode D, can be referred to ground.

The primary winding W1 of the transformer T (at the ends of which a circuit SC may be arranged to act as a “snubber”) may be acted upon by an electronic switch PS, such as a power transistor (for example a MOSFET transistor, such as a PMOS), the control terminal of which (e.g, gate, in the case of a field-effect transistor such as a MOSFET) is driven by a drive output GD of the circuit 10 discussed below.

An amperometric sensing resistor RS (which may be referred to herein as sensor RS) interposed between the transistor PS and ground is able to supply a signal (e.g. a voltage) indicative of the intensity of the current flowing on the current path (e.g., source-drain in the case of a field-effect transistor such as a MOSFET) of the power transistor PS, and therefore at least approximately on the primary winding W1 of the transformer T, to a sensing input CS of the circuit 10.

Reference sign VD is used to indicate a voltage divider coupled to the output voltage VOUT that is designed to transfer a scaled version of the voltage VOUT to a feedback input FB of the circuit 10.

The circuit 10 may include a pulse width modulation (PWM) generator circuit 100 (i.e. a rectangular-wave switched signal generator) that is designed to generate a signal (for example with a duty cycle that is selectively variable according to the criteria regulating generation of a PWM signal) that can be used to drive, for example via a driver 102, the output GD and therefore the control terminal of the power switch (power MOS) PS.

Operation of the generator circuit 100 can be controlled by a circuit 104 (e.g. an operational amplifier) having differential inputs.

One of the inputs (for example the non-inverting input) of the circuit 104 is coupled to the amperometric input CS such as to receive the signal from the sensor RS.

The other input (for example the inverting input) of the circuit 104 can, on the other hand, receive another signal designed to be generated according to methods that are at least partially different in the different example solutions shown in FIGS. 1, 2, 4 and 5.

Reference numeral 106 indicates an oscillator (shown here as inside the circuit 10, but which could also be positioned outside) that is designed to generate an oscillator signal that can be assumed to be a fixed frequency f_{osc}. In this regard, it can be seen that the different components discussed above and shown in FIGS. 1, 2, 4 and 5 as being outside the circuit 10 may be different elements in different embodiments.

It has been observed that the different solutions discussed previously in the technological background may involve the presence of a dedicated pin (for example a pin referred to as COMP that is connected to the output of a transconductor EA) connected to a compensating network typically formed of two capacitors and one resistor to form a pole and a zero. The features and the choice of the compensating network depend on the type of application chosen and on the operating mode and on the value of the output capacitor Cout and of the related equivalent series resistance (ESR).

One or more embodiments such as the examples shown herein make it possible to provide a voltage control system that is entirely integrated without the use of a compensating network and the aforementioned pin, thereby reducing the number of components required and consequently also the cost and size of the entire application.

In this regard, it has been observed that one type of robust, intrinsically stable control that does not require the provision of a compensating network is the ON-OFF control shown by way of example in FIG. 1, including an ON-OFF comparator 108 that compares the voltage feedback signal on to input FB to a reference voltage REF, and the output of which is brought to logically AND (in a gate no) with the clock signal CLK of the oscillator 106.

Accordingly, the output of the comparator 108 can control the clocking of the generator wo by a signal ONpmos. The output of the comparator 108 performs a gating action on the signal CLK that in practice “passes” or “does not pass” towards the generator 100 (enabling same to generate the pulses of the signal GD) depending on whether the output ON_OFF of the comparator 108 is “on” (for example feedback voltage at feedback input FB being less than reference voltage REF, for which the transistor PS is activated to increase the voltage VOUT) or “off” (for example with the feedback voltage at feedback input FB reaching reference voltage REF, for which the transistor PS is powered down such as not to increase the voltage VOUT.

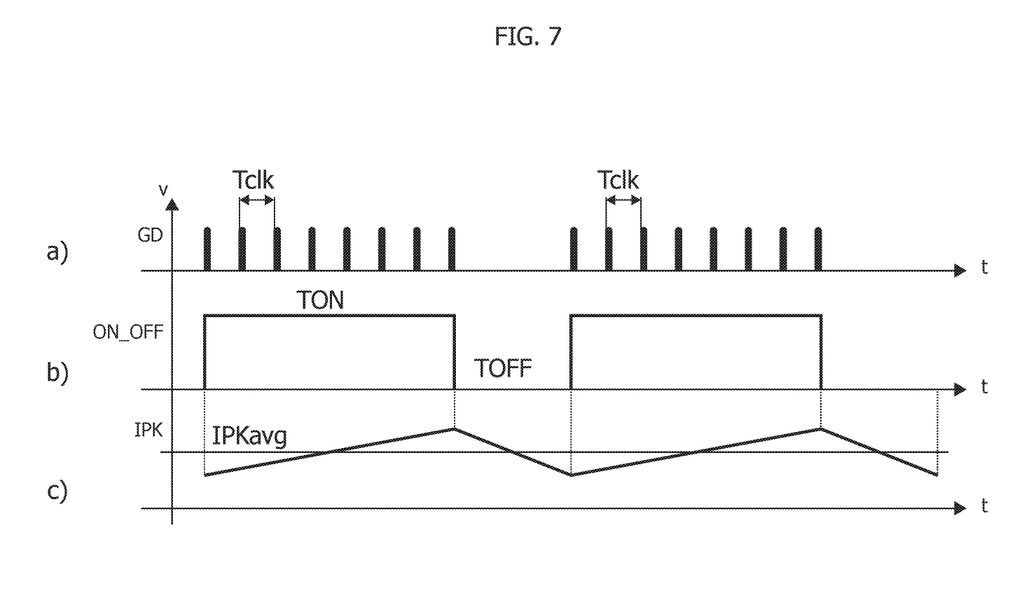

This behaviour is exemplified in diagrams (a) and (b) in FIG. 7 (discussed further below), in which Tclk indicates the period of the pulses of the signal GD, which is equal to 1/f_{osc} where f_{osc} indicates the frequency of the clock signal CLK generated by the oscillator 106.

These diagrams show why, after such powering up and powering down, the impulses of the signal GD may have a mean frequency f_{sw}_{_}_{avg} that is different from f_{osc}.

The signal IPKmax is brought to the input (for example inverting) of the circuit 104, the amperometric signal of the input CS being applied to the other input of same.

Such an ON-OFF controls topology is used to control the generator 100 to perform switching cycles with a primary peak current that is dependent on the voltage IPKmax and on the resistance RS.

The primary current peak is determined by the comparator of the reset of the PWM generator comparing the voltage on the input CS with the voltage IPKmax and therefore the primary current depends on the value of IPKmax and on the value of the resistance RS (for example being proportional or equal to IPKmax/RS).

The resistance RS can be selected such as to facilitate achievement, at the highest switching frequencies set by the circuit 106 and equal to f_{osc}, for example of the lowest input voltage Vin and of the highest current on the load LOAD.

It has been noted that, for example when the load LOAD requires current values lower than a given value I_{LOADmax}, the ON-OFF control system reduces the mean switching frequency f_{sw}_{_}_{avg} skipping ON cycles when the voltage on the input FB is greater than REF. The system therefore works with energy packets (see again diagram (a) in FIG. 7), the mean switching frequency f_{sw}_{_}_{avg} of which depends on the current required by the load LOAD.

As outlined in FIG. 1, this solution may have the drawback of having a switching frequency that is likely to be variable with the load (potentially significantly), which may for example hinder applications for which efficient performance is required in terms of conducted and radiated EMI.

For example, for load levels of 3 A and 1.5 A (naturally, such values are provided purely by way of example), there may be very different signal spectra on the drain of the resistor PS. Furthermore, when the loads are medium-low (for example 0.7 A), the mean switching frequency may fall in the audible band and this may therefore result in acoustic noise issues caused by vibrations of the transformer T during the magnetization phase. This requires the use of expensive transformers obtained using specific construction techniques that minimize vibration.

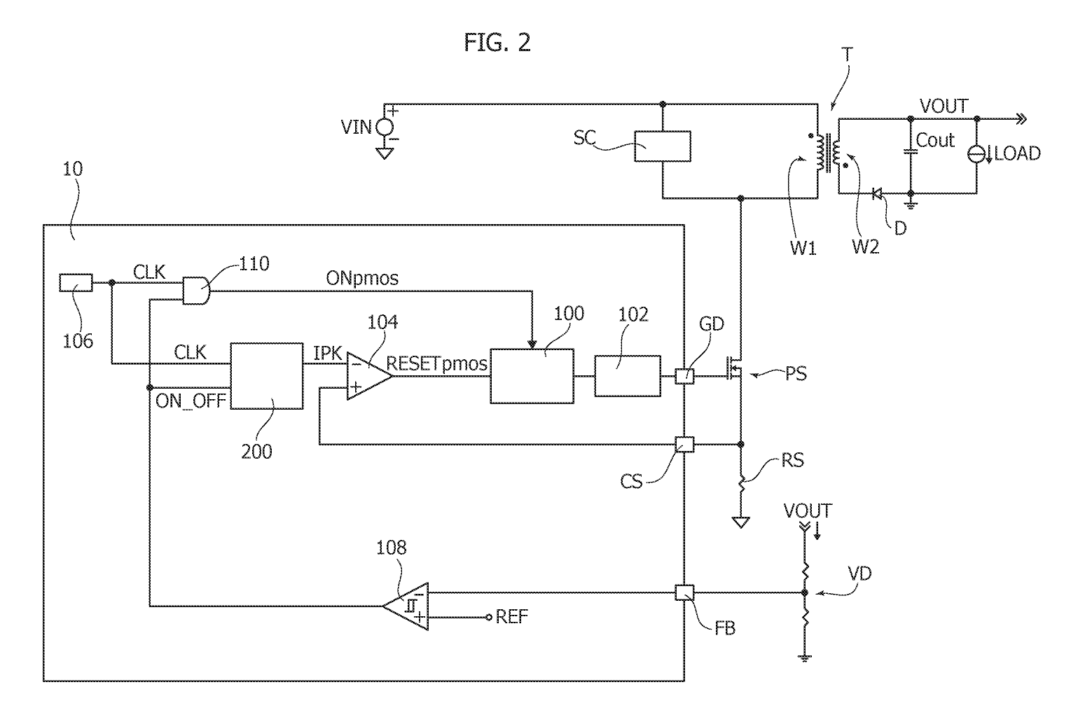

One way to obviate this problem is as exemplified in FIG. 2, where portions or elements corresponding to portions or elements already described in relation to FIG. 1 are indicated using the same reference signs, and without repeating the related description.

One or more embodiments (see for example the solution shown by way of example in FIG. 2) may involve regulating the value of the input parameter IPKmax of the circuit 104 via a circuit 200 such that, for a given current value I_{LOAD} required by the load, the frequency f_{sw}_{_}_{avg} is kept constant and close to the fixed value f_{osc} determined by the oscillator 106.

It has been observed that, if an on/off control strategy is implemented following reduction of the load current to enable the value of the current peak to be lowered by lowering the voltage IPKmax causing the “on” cycles to take precedence over the “off” cycles, i.e. causing the generator 100 to be as active or powered up as possible (consistent with the requirement to maintain the desired VOUT value indicated by the feedback signal FB) it is possible to obtain a near-constant mean switching frequency f_{sw}_{_}_{avg}.

One or more embodiments may therefore involve inserting, in an ON-OFF control system, a system (for example a circuit 200) configured to find a given value (or “optimum” value) of the primary peak current liable to make the mean switching frequency f_{sw}_{_}_{avg} constant as the load changes and close to the frequency f_{osc} set by the oscillator (for example internal) 106 and to make the harmonic content of the switching signals of the application similar to a fix switching frequency system that is independent of the load.

In one or more embodiments, this may be done using the circuit 200 that, in one or more embodiments, may receive as input the signal CLK (outputted from the oscillator 106) and the signal ON_OFF (outputted from the comparator 108), achieving the primary objective of regulating the value of the primary current peak IPK, reducing the off times to a lower limit and increasing the on cycles in a compatible manner.

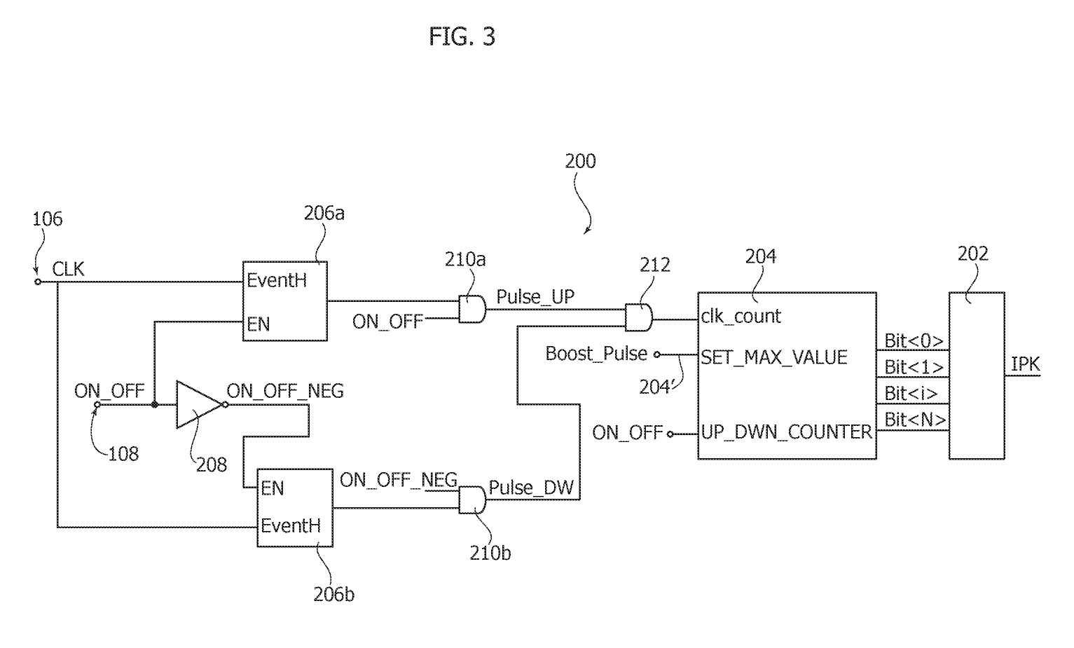

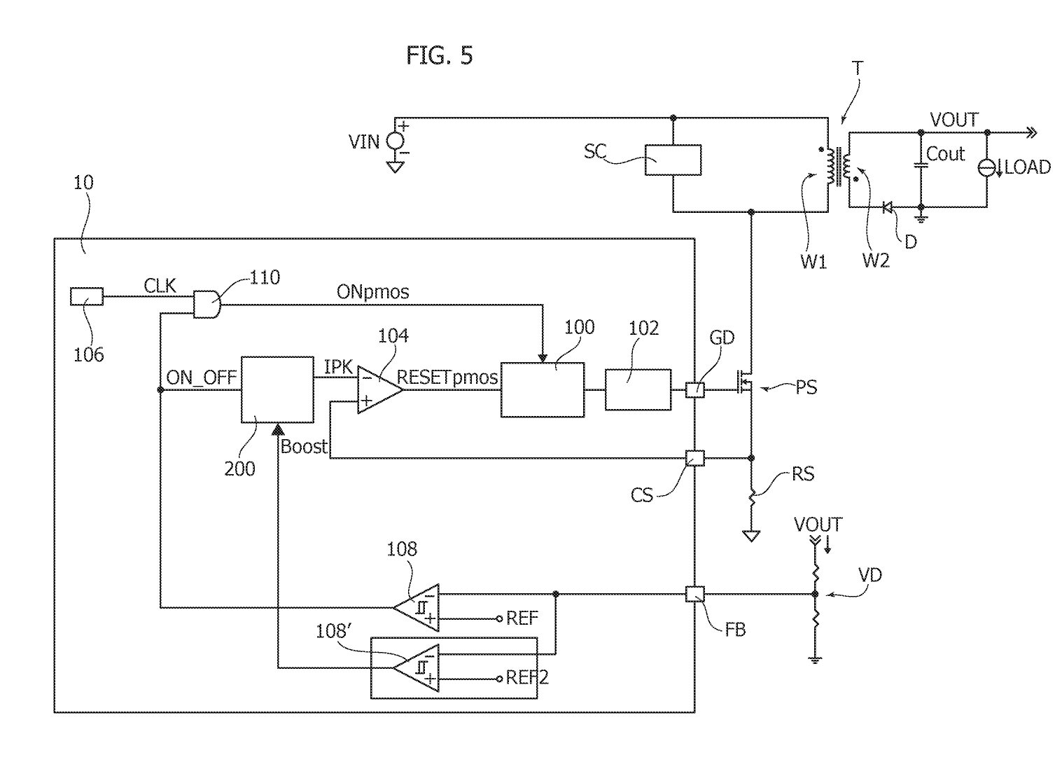

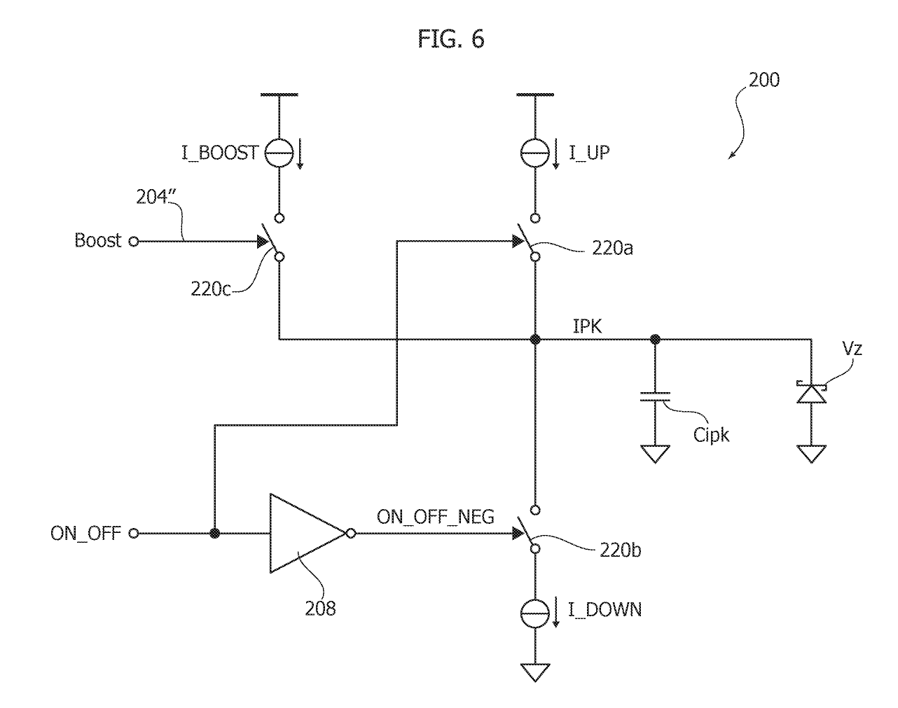

FIG. 3 shows a possible example “digital” implementation of one or more embodiments, and a possible “analog” implementation is discussed below with reference to FIGS. 5 and 6.

For the sake of simplicity when illustrating the output, in the example implementation shown in FIG. 3, the block 200 may include a digital-analog converter (DAC) 202, for example with N bits, for generating the (analog) signal IPK powered by an up and down counter (UP-DOWN) 204 that generates a set of digital bus outputs Bit<0, . . . , N> at the input of the converter 202.

The counter 204 is driven by two additional counters 206a, 206b that can be defined as “COUNTER Non” and “COUNTER Noff” respectively. These counters release a pulse after counting a certain number of CLK events of the incoming signal from the oscillator 106.

The number of such events is “Non” in the case of the counter “COUNTER Non” 206a and “Noff” in the case of the counter “COUNTER Noff” 206b.

For example, each counter 206a, 206b may start counting when an (enabling) input EN goes high, and is reset each time EN goes low. In all cases, the input EN of the counter 206a receives the signal ON_OFF from the comparator 108 and the input EN of the counters 206b receives the same signal ON_OFF in negated form ON_OFF_NEG via a logic inverter 208.

For the sake of completeness, it can be seen that, in one or more embodiments, the counter signals “COUNTER Non” (206a) and “COUNTER Noff” (206b) can be transferred to the counter UP/DOWN 204 as pulses Pulse_UP and Pulse_DOWN via AND gates 210a and 210b, which receive the signals ON_OFF and ON_OFF_NEG on the other inputs with such pulses flowing on an OR gate 212, which in turn drives the counter 204 (input clk_count).

For example, when the signal ON_OFF is high (in which state the system provides energy to the load, enabling the release of the pulses ONpmos at the frequency f_{osc} of the oscillator 106) and remains so for a number “Non” of CLK events, the counter “COUNTER Non” 206a releases a pulse Pulse_UP, which increases the count of the counter 204 by one circuit and consequently the signal IPK increases by one step (for example voltage step equal to (IPKmax−IPKmin)/2N where N is the number of bits of the DAC).

In one or more embodiments, IPKmax can be the voltage value that is an upper limit of the primary current peak and IPKmin is the lower limit.

If ON_OFF goes low before the counter has counted “Non”, the counter is internally reset without releasing any pulses. When ON_OFF is low (in which state the system does not supply energy to the load, preventing the release of the impulses ONpmos), the counter “COUNTER Noff” 206b releases a pulse Pulse_DW once a number of CLK events equal to “Noff” has been counted. No pulse is released if ON_OFF goes high before the counter reaches said number, again resetting the internal counter.

In one or more embodiments, the number of power-up cycles can be increased and the number of power-down cycles can be decreased, establishing “Non”>>“Noff”.

Indeed, for a given current value of the load I_{LOAD}, the system described above adjusts the value of IPK about a value in which the number of cycles skipped does not exceed “Noff” and the number of power-up cycles is “Non” or a few cycles more.

Assuming that the number of power-up cycles is exactly “Non” and the number of skipped cycles is “Noff”, the mean switching frequency f_{sw}_{_}_{avg} can be expressed as follows:

f_{sw}_{_}_{avg}=[Nₒₙ/(Nₒₙ+N_{off})]·f_{osc}

The ratio shows that for Non>>Noff the value f_{sw}_{_}_{avg} is close to the frequency f_{osc} imposed by the oscillator 106, with the ON-OFF system tending to operate almost always in ON, facilitating achievement of a spectral content of the switching signals that is similar to the spectral content of a fixed-frequency system.

For example, for a given load current value I_{LOAD}, assuming that the value of IPK is initially at a value higher than a given reference value (“reference” being determined such as to enable the system to work as a fixed-frequency system for a given current level of the load I_{LOAD}), the system will modify the value of IPK using the method described above and after a certain number of clock “beats” (CLK events) the voltage IPK will settle at a value for which the mean switching frequency is close to the value set by the ratio given above.

If I_{LOAD} varies, the new value of IPK will be sought, thereby keeping the mean frequency substantially constant as the load varies.

For example, assuming that Noff=1 and Non=7 (purely by way of non-limiting example), in steady state the value of IPK oscillates between two values such that the power-ups last for 7 power-up cycles while the power-up skip period lasts for just 1 CLK cycle.

Experiments carried out with reference to a value f_{osc}=100 kHz have demonstrated that the mean switching frequency is kept near constant. Still, the spectral content observed in the drain node of the transistor PS when I_{LOAD}=1.5 A and I_{LOAD}=3 A respectively does not reveal major differences between the two loads and has a dominant harmonic content at the frequency f_{osc}=100 kHz and multiples.

It has also been observed that one or more of the embodiments shown by way of example in FIG. 2 may be influenced by a certain slowness in the positive variations of the voltage IPK as a result of the dependency on “Non”, f_{osc} and the levels “2^{N}” of the converter 202.

This could be the cause of critical aspects in the case of load transients from low current values to high current values such as, in the worst-case scenario, from zero load to maximum load. In this case, a certain slowness in the increase of IPK could result in an unwanted drop in the output voltage to values that are not compatible with certain applications.

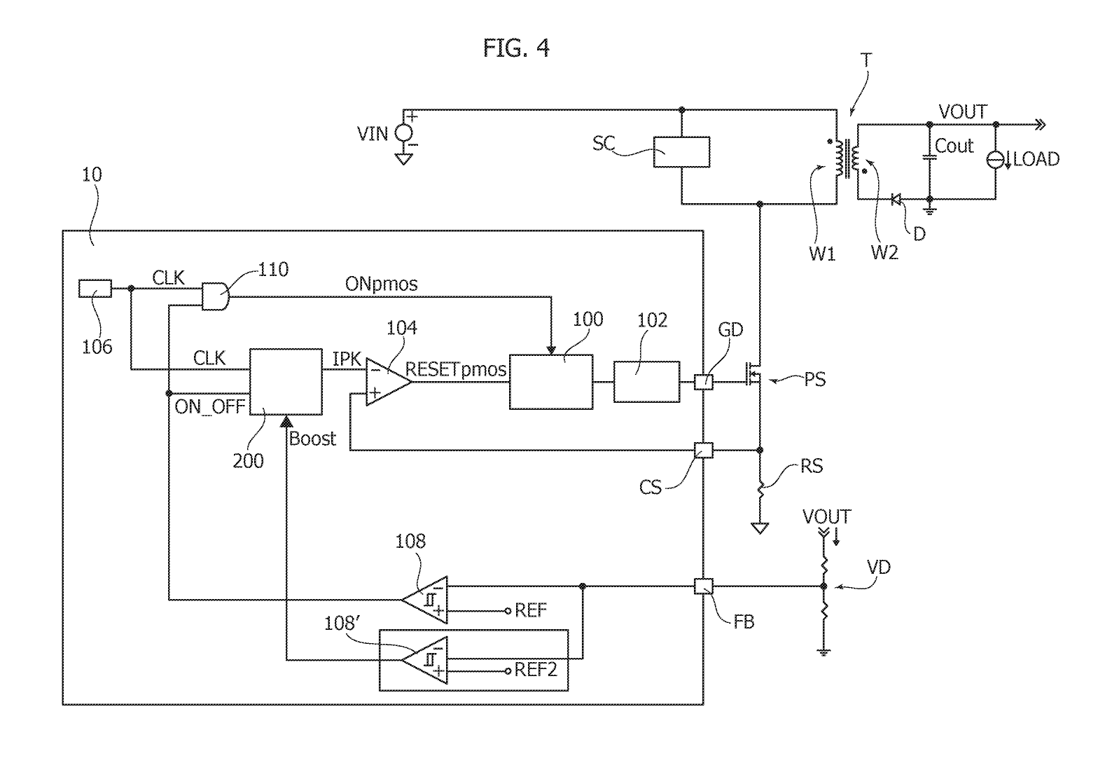

One or more embodiments may address this aspect using an additional comparator (108′ in FIG. 4, where portions or elements corresponding to portions or elements already described in relation to FIG. 3 are indicated using the same reference signs) that monitors the voltage on the input FB in relation to an additional reference REF2 that is for example less than REF.

When the voltage VOUT and therefore the related feedback signal on FB drop below the level REF2, the comparator 108′ can send a boost pulse (see for example 204′ in FIG. 3), which sets the DAC 202 to the maximum value IPKmax, after which the “optimum” IPK can be sought in the terms described above.

It has been observed that there is no appreciable voltage overshoot in the case of a maximum-to-zero transient, this being attributable to the natural primary regulation control ON-OFF mechanism, which prevents the provision of energy when the input signal FB is higher than REF.

FIGS. 5 and 6 show one or more example embodiments in which the circuit 200 can be made in a similar manner.

Again in FIG. 5, portions or elements corresponding to portions or elements already described in relation to FIGS. 2 and 4 are indicated using the same reference line, and without repeating the related description.

FIG. 6 shows possible example embodiments in which the signal IPK that defines the primary current peak can be given by a voltage at the ends of a capacitor Cipk, this voltage (which can be limited to a value VIPKmax, for example by a Zener diode Vz) being obtainable by charging the capacitor Cipk with a current I_UP during the TON phase, i.e. the phase in which the comparator 108 of the control ON-OFF operates such as to transfer energy to the load LOAD by means of power-ups at the (constant) frequency f_{osc}=1/T_{clk} of the oscillator 106, discharging same with a current I_DOWN during the TOFF phase (phase in which no energy is transferred to the load).

In one or more embodiments, the currents I_UP and I_DOWN can be generated using current sources (of a known type) that can be activated, as shown schematically by the two switches 220a and 220b, by respective signals ON_OFF and ON_OFF_NEG that can be generated as discussed above.

For a given current level in the load I_{LOAD} and in steady-state condition, the voltage IPK oscillates about a mean value IPKavg, according to a ratio such as the following:

I_UP·TON/Cipk=I_DOWN·TOFF/Cipk

from which the following ratio can be obtained:

TON/TOFF=I_DOWN/I_UP

The mean switching frequency in steady-state conditions can therefore be expressed as follows:

f_{sw}_{_}_{avg}=[TON/(TON+TOFF)]·f_{osc}

from which, dividing numerator and denominator for TOFF and replacing the above equation gives:

$$\begin{matrix}{f}_{sw\_avg} = \{ ( TON / TOFF ) / [ ( TON / TOFF ) + 1 ] \} \cdot {f}_{osc} = \\ = \{ ( I\_DOWN / I\_UP ) / [ ( I\_DOWN / I\_UP ) + 1 ] \} \cdot {f}_{osc}\end{matrix}$$

By again ensuring I_DOWN>>I_UP in this case, it is possible to ensure that the mean frequency is close to the frequency imposed by the oscillator f_{osc} and in particular that said frequency does not vary appreciably as the load varies.

Indeed, if the load should reduce the value of IPK after a given transient, same will settle at a lower value and in steady state the mean switching frequency will be as given by the aforementioned ratio.

Again in this case, where I_DOWN may be (much) greater than I_UP, the positive variations in IPK could be slow, and potentially critical for example in the presence of a low-to-high load transient.

Again in this case, one or more embodiments may use a comparator 108′ to generate a boost signal when the voltage on the input FB drops below a reference REF2<REF.

When the boost signal is for example high, the capacitor Cipk can be charged rapidly with a current I_BOOST produced by a generator (of unknown type) that is designed to be activated, as shown schematically by a switch 220C, by the boost signal itself, necessarily increasing the energy to be transferred to the load and preventing an unwanted drop in the output voltage V_{OUT}.

The diagram in part (c) in FIG. 7 shows a possible example progression of the signal IPK as detected at the output of the converter 202 in FIG. 3 (“digital” version) or on the capacitor Cipk in FIG. 6 (analog version) compared to a possible progression of the signal GD at the output of the generator 100 and of the signal ON_OFF at the output of the comparator 108, showing the possible variations in relation to a mean value IPK_{avg}.

It can also be seen how the use of one or more embodiments can be compared by determining, for example, the behaviour of the signal on the drain of the transistor PS, the absence in the circuit of pin inputs COMP and/or the absence of an external regulating network.

One or more embodiments may therefore concern a circuit (for example 10) including: a driving terminal (for example GD) couplable to the control terminal of a power transistor (for example PS) for power supply of a load (for example T, LOAD); an amperometric input (for example CS) for detecting an amperometric signal, said amperometric signal indicative of the intensity of the current flowing through said power transistor for the power supply of said load; a feedback input (for example FB) for detecting a feedback signal (for example VD), said feedback signal indicative of the voltage (for example VOUT) applied to said load powered by said power transistor; a switched signal generator (for example 100) coupled to said driving terminal to control the generation of primary current peaks by said power transistor; a clock line (for example 106) for clocking (for example CLK, ONpmos) said generator (100) at a clock oscillation frequency, f_{osc}; coupled to said feedback input, at least one feedback comparator (for example 108) for comparing said feedback signal to at least one reference level (for example REF); a gating circuit (for example the gate no) driven (see for example the signal ON_OFF) in on and off cycles by said at least one feedback comparator, with the switched signal generator coupled (for example via the signal ONpmos) to said gating circuit in an activated state in said on cycles and in a deactivated state in said off cycles, said primary current peaks having a mean frequency, f_{sw}_{_}_{avg}, which is a function of said on and off cycles (see for example FIG. 7); a driving comparator (for example 104) of said generator, said driving comparator having comparison inputs coupled to said amperometric input and to a circuit (for example 200) for determining the value of said primary current peaks (for example IPK), wherein the voltage applied to said load powered by said power transistor is a function of the value of said primary current peaks, wherein said determination circuit is coupled (for example via the ON/OFF signal) to said at least one feedback comparator and is configured to regulate the value of said primary current peaks by regulating the voltage applied to said load powered by said power transistor maintaining said mean frequency, f_{sw}_{_}_{avg}, close (and substantially equal) to said clock oscillation frequency, f_{osc}.

In other words, one or more embodiments may involve providing a determination circuit coupled (for example via the ON/OFF signal) to said at least one feedback comparator and configured to regulate the value of said primary current peaks by regulating the voltage applied to said load powered by said power transistor, with the target of regulating said mean frequency, f_{sw}_{_}_{avg} to said clock oscillation frequency, f_{osc}.

In one or more embodiments, said determination circuit may be configured to regulate the value of said primary current peaks with said off cycles reduced in favour of the on cycles, with the ratio between the number or duration of the on cycles and the number or the total duration of the on and off cycles (for example Nₒₙ/(Nₒₙ+N_{off}) or TON/(TON+TOFF)) close (and substantially equal) to unity.

In other words, one or more embodiments may involve said determination circuit being configured to regulate the value of said primary current peaks with said off cycles reduced in favour of the on cycles, with the regulation target being a unitary ratio between the number or duration of the on cycles and the number or the total duration of the on and off cycles (for example Nₒₙ/(Nₒₙ+N_{off}) or TON/(TON+TOFF)).

As is known, target means a value that a control system aims to achieve and that determines the behaviour of the system, even if said value can be designed to be obtained in an exact manner.

In one or more embodiments, said determination circuit may include a first (for example 206a) and a second counter (for example 206b) for counting the pulses of the clock (106) clocking said generator, said first and second counters being enabled and disabled for counting in a complementary fashion (see for example the inverter 208) by said on and off cycles of said at least one feedback comparator; an up and down counter (for example 204) having a value of said primary current peaks as an output (for example the DAC 202), said up and down counter being driven to count up and down, respectively, by the one and the other of said first counter and second counter.

In one or more embodiments, said determination circuit may include: a capacitor (for example Cipk) for accumulating an electric charge indicative of the value of said primary current peaks; a first (for example I_UP) and a second (for example I_DOWN) generator for charging and discharging, respectively, said capacitor, said first and second generator being enabled and disabled in a complementary fashion (for example 208) by the on and off cycles of said at least one feedback comparator.

One or more embodiments may include, coupled to said feedback input, at least one additional comparator (for example 108′) for comparing said feedback signal to at least one additional reference level (for example REF2, which may be lower than REF), said additional comparator being coupled to said determination circuit to boost (for example Boost; 204′, 204″) the value of said primary current peaks (IPK) to an upper limit as a result of the feedback signal at said feedback input falling below said additional reference level.

In one or more embodiments, said additional comparator may be coupled to said up and down counter in said determination circuit to boost the output of said up and down counter to an upper counting limit (for example SET_MAX_VALUE).

In one or more embodiments, said additional comparator may be coupled to an additional charge generator of said capacitor to charge said capacitor to an upper charge limit (for example Vz).

In one or more embodiments, a power supply may include: a transformer (for example T) with a primary winding (for example W1) and a secondary winding (for example W2) couplable to a powered load (for example LOAD); a power transistor driving the primary winding of the transformer, the power transistor having a control terminal; an amperometric sensor (for example RS) sensitive to the current flowing in the power transistor, and a feedback network (for example VD) sensitive to the voltage (for example VOUT) applied to said load, where a circuit according to one or more embodiments having said driving terminal coupled to the control terminal of said power transistor, said amperometric control input being coupled to said amperometric sensor and said feedback input being coupled to said feedback network.

An apparatus according to one or more embodiments may include a battery charger.

A method for using a circuit according to one or more embodiments may include: providing a transformer with a primary winding and a secondary winding coupled to a powered load; providing a power transistor driving the primary winding of the transformer, the power transistor having a control terminal; providing an amperometric sensor which can sense the current flowing in the power transistor; providing a feedback network sensitive to the voltage applied to said load; coupling said driving terminal to the control terminal of said power transistor; coupling said amperometric control input to said amperometric sensor; coupling said feedback input to said feedback network; activating the switched signal generator in said on cycles and deactivating the switched signal generator in said off cycles, with said primary current peaks having a mean frequency, which is a function of said on and off cycles; and f_{sw}_{_}_{avg}, regulating the value of said primary current peaks by regulating the voltage applied to said load powered by said power transistor (PS), maintaining said mean frequency, f_{sw}_{_}_{avg}, close to said clock oscillation frequency, f_{osc}.

In other words, one or more embodiments may involve regulating the value of said primary current peaks by regulating the voltage applied to said load powered by said power transistor (PS), with the target of regulating said mean frequency, f_{sw}_{_}_{avg} to said clock oscillation frequency, f_{osc}.

Notwithstanding the basic principles, the implementation details and embodiments may vary, even significantly, from those given here purely by way of non-limiting example, without thereby moving outside the scope of protection.

1. A circuit, comprising:
a driving terminal configured to drive a control terminal of a switch for power supply of a load;
an amperometric input configured to detect an amperometric signal, the amperometric signal being indicative of a current intensity flowing through the switch;
a feedback input configured to detect a feedback signal, the feedback signal being indicative of a voltage applied to the load powered by the switch;
a feedback comparator configured to compare the feedback signal to a reference level;
a switched signal generator having an output coupled to the driving terminal and configured to control generation of primary current peaks by the switch; and
a gating circuit configured to be clocked at a clock oscillation frequency, the gating circuit having an output coupled to the switched signal generator, the gating circuit being configured to be driven in an on cycle and an off cycle by the feedback comparator, wherein the switched signal generator is configured to be in an activated state in the on cycle and in a deactivated state in the off cycle, and wherein the primary current peaks have a mean frequency that is a function of the on and off cycles.

2. The circuit according to claim 1, wherein the switched signal generator comprises a driving comparator having comparison inputs coupled to the amperometric input and a determination circuit configured to determine a value of the primary current peaks, wherein the voltage applied to the load is a function of the value of the primary current peaks.

3. The circuit according to claim 2, wherein the determination circuit is coupled to the feedback comparator and configured to regulate the value of the primary current peaks by regulating the voltage applied to the load.

4. The circuit according to claim 3, wherein the mean frequency is equal to the clock oscillation frequency.

5. The circuit according to claim 2, further comprising the determination circuit, the determination circuit being further configured to regulate the value of the primary current peaks with a ratio between a number or a duration of the on cycle and a total number or a total duration of the on cycle and the off cycle being substantially equal to unity.

6. The circuit according to claim 1, wherein the switch comprises a power transistor.

7. The circuit according to claim 2, wherein the determination circuit comprises:
a first counter and a second counter for counting pulses of a clock clocking the switched signal generator, the first counter and second counter being enabled and disabled for counting in a complementary fashion by the on and off cycles of the feedback comparator; and
an up and down counter having a value of the primary current peaks as an output, the up and down counter being driven to count up by the first counter and to count down by the second counter.

8. (canceled)

9. The circuit according to claim 2, further comprising an additional comparator coupled to the feedback input, the additional comparator being configured to compare the feedback signal to an additional reference level, the additional comparator being coupled to the determination circuit to boost the value of the primary current peaks to an upper limit as a result of the feedback signal at the feedback input falling below the additional reference level.

10. The circuit according to claim 9, wherein the additional comparator is coupled to an up and down counter in the determination circuit to boost an output of the up and down counter to an upper counting limit.

11. The circuit according to claim 9, wherein the additional comparator is coupled to an additional generator for charging a capacitor of the determination circuit to an upper charge limit.

12. A power supply, comprising:
a transformer with a primary winding and a secondary winding configured to be coupled to a powered load;
a power transistor configured to drive the primary winding of the transformer, the power transistor having a control terminal;
an amperometric sensor sensitive to a current flowing in the power transistor;
a feedback network configured to generate a feedback signal indicative of a voltage applied to the powered load; and
a circuit, comprising:
a driving terminal coupled to a control terminal of the power transistor;
an amperometric control input coupled to the amperometric sensor;
a feedback input coupled to the feedback network;
a feedback comparator configured to compare the feedback signal to a reference level;
a switched signal generator having an output coupled to the driving terminal and configured to control generation of primary current peaks by the power transistor; and
a gating circuit configured to be clocked at a clock oscillation frequency, the gating circuit having an output coupled to the switched signal generator, the gating circuit being configured to be driven in an on cycle and an off cycle by the feedback comparator, wherein the switched signal generator is configured to be in an activated state during the on cycle and in a deactivated state during the off cycle.

13-14. (canceled)

15. The power supply according to claim 12, wherein the switched signal generator comprises a driving comparator having comparison inputs coupled to the amperometric control input and a determination circuit configured to determine a value of the primary current peaks, wherein the voltage applied to the powered load is a function of the value of the primary current peaks.

16. A method, comprising:
driving a control terminal of a switch for power supply of a load using a driving terminal of a circuit;
detecting an amperometric signal using an amperometric input of the circuit, the amperometric signal being indicative of a current intensity flowing through the switch;
detecting a feedback signal using a feedback input of the circuit, the feedback signal being indicative of a voltage applied to the load powered by the switch;
comparing the feedback signal to a reference level using a feedback comparator;
controlling a generation of primary current peaks by the switch using a switched signal generator having an output coupled to the driving terminal;
driving a gating circuit in an on cycle and an off cycle by the feedback comparator, the gating circuit having an output coupled to the switched signal generator;
activating the switched signal generator in the on cycle and deactivating the switched signal generator in the off cycle, with the primary current peaks having a mean frequency that is a function of the on and off cycles; and
regulating the primary current peaks by regulating the voltage applied to the load.

17. The method according to claim 16, further comprising clocking the gating circuit at a clock oscillation frequency.

18. The method according to claim 17, wherein regulating the primary current peaks comprises maintaining the mean frequency in proximity of the clock oscillation frequency.

19. The method according to claim 16, wherein regulating the primary current peaks comprises regulating the primary current peaks with a ratio between a number or a duration of the on cycle and a total number or a total duration of the on cycle and the off cycle being substantially equal to unity.

20. The method according to claim 16, further comprising comparing the feedback signal to an additional reference level using an additional comparator to boost the primary current peaks to an upper limit as a result of the feedback signal at the feedback input falling below the additional reference level.

21. The power supply according to claim 15, wherein the determination circuit is coupled to the feedback comparator and configured to regulate the value of the primary current peaks by regulating the voltage applied to the powered load.

22. The power supply according to claim 15, further comprising the determination circuit, wherein the determination circuit comprises:
a first counter and a second counter for counting pulses of a clock clocking the switched signal generator, the first counter and second counter being enabled and disabled for counting in a complementary fashion by the on and off cycles of the feedback comparator; and
an up and down counter having a value of the primary current peaks as an output, the up and down counter being driven to count up by the first counter and to count down by the second counter.

23. The power supply according to claim 15, further comprising an additional comparator coupled to the feedback input, the additional comparator being configured to compare the feedback signal to an additional reference level, the additional comparator being coupled to the determination circuit to boost the value of the primary current peaks to an upper limit as a result of the feedback signal at the feedback input falling below the additional reference level.
